(19) United States
(12) Patent Application Publication
(10) Pub. No.: US 2011/0187834 A1
(43) Pub. Date: Aug. 4, 2011

(54) RECORDING DEVICE AND RECORDING METHOD, IMAGE PROCESSING DEVICE AND IMAGE PROCESSING METHOD, AND PROGRAM

(76) Inventors: Takafumi MORIFUJI, Tokyo (JP); Masami Ogata, Kanagawa (JP); Suguru Ushiki, Tokyo (JP)

(21) Appl. No.: 13/015,563

(22) Filed: Jan. 27, 2011

(30) Foreign Application Priority Data
Feb. 3, 2010 (JP) 2010-022372

(51) Int. Cl. H04N 13/02

(52) U.S. Cl. 348/47; 348/E13.074

(57) ABSTRACT

A recording device includes an image acquiring section which acquires 3D image data, a filming condition acquiring section which acquires filming condition information indicating filming conditions during filming of the 3D image data, and a recording controlling section which causes a recording medium to record the 3D image data and the filming condition information by making the data and the information correspond to each other.

### BACKGROUND OF THE INVENTION

1. Field of the Invention

The present invention relates to a recording device and a recording method, an image processing device and an image processing method, and a program, and particularly to a recording device and a recording method, an image processing device and an image processing method, and a program which enable a more natural display of 3D images.

2. Description of the Related Art

2D images are still the mainstream for contents such as movies, but in recent years 3D images have started to attract attention.

A playback device for playing back 3D images, for example, displays images filmed simultaneously by two cameras alternately. At this time, a user wears, for example, an eyeglass with shutter which is synchronized to shifting images, and sees images filmed by the first camera only with the left eye and images filmed by the second camera only with the right eye. Thereby, the user can see 3D images.

In addition, as a playback device for playing back 3D images, there is a device which displays 3D images by synthesizing a telop therewith (for example, refer to Japanese Unexamined Patent Application Publication No. 10-327430).

### SUMMARY OF THE INVENTION

Such a playback device for playing back 3D images displays 3D images that have been recorded as they are, but when filming conditions and display conditions do not correspond to each other, unnatural 3D images are displayed since the display location in a direction perpendicular to the display surface of the 3D images is greatly different from the location in a direction perpendicular to the filming surface of a subject in the filming of 3D images.

In other words, since the playback devices of the related art for playing back 3D images are not able to recognize the filming conditions of the 3D images, the devices are not able to display 3D images to suit the filming conditions and the display conditions, the display of natural 3D images is thus challenging.

The present invention takes the above difficulty into consideration, and it is desirable to display more natural 3D images.

A recording device according to an embodiment of the present invention includes an image acquiring section which acquires 3D image data, a filming condition acquiring section which acquires the filming condition information indicating the filming conditions during the filming of the 3D image data, and a recording controlling section which causes a recording medium to record the 3D image data and the filming condition information by making the data and the information correspond to each other.

A recording method and a program according to the embodiment of the present invention correspond to the recording device of the embodiment of the present invention.

According to the embodiment of the present invention, 3D image data are acquired, the filming condition information indicating the filming conditions during the filming of the 3D image data is acquired, and the 3D image data and the filming condition information correspond to each other and are recorded on a recording medium.

The image processing device according to another embodiment of the present invention includes an acquiring section which acquires 3D image data and filming condition information read from a recording medium in which the 3D image data and the filming condition information indicating the filming conditions during the filming of the 3D image data are recorded in correspondence with each other, a parallax controlling section which corrects the parallax of the 3D image data based on the display condition information indicating the display conditions of the 3D image data and the filming condition information, and a display controlling section which causes a display unit to display 3D images based on the 3D image data of which the parallax is corrected by the parallax controlling section.

An image processing method and a program according to the embodiment of the present invention correspond to the image processing device of the embodiment of the present invention.

According to the embodiment of the present invention, 3D image data and filming condition information are acquired and read from a recording medium in which the 3D image data and the filming condition information indicating the filming conditions during the filming of the 3D image data are recorded in correspondence with each other, the parallax of the 3D image data is corrected based on the display condition information indicating the display conditions of the 3D image data and the filming condition information, and 3D images are displayed in a display unit based on the 3D image data of which parallax is corrected.

According to an embodiment of the present invention, the filming condition information can be provided in correspondence with the 3D image data. Thereby, more natural 3D images can be displayed in a device for displaying 3D images corresponding to the 3D image data.

In addition, according to another embodiment of the present invention, more natural 3D images can be displayed.

### BRIEF DESCRIPTION OF THE DRAWINGS

FIG. 1 is a block diagram illustrating a composition example of a first embodiment of a recording system to which the present invention is applied;

FIG. 2 is a diagram illustrating the parameters indicating the filming conditions in a camera;

FIG. 3 is a diagram illustrating the parameters indicating the display conditions of the 3D image data;

FIG. 4 is a diagram illustrating the relationship between the filming distance and the display distance;

FIG. 5 is another diagram illustrating the relationship between the filming distance and the display distance;

FIG. 6 is a flowchart describing the recording control process of a recording device;

FIG. 7 is a block diagram illustrating a composition example of a playback system which plays back a recording medium shown in FIG. 1;

FIG. 8 is a diagram describing a calculation method of the display distance;

FIG. 9 is a flowchart describing an image processing of a playback device of FIG. 7;

FIG. 10 is a block diagram illustrating another composition example of a playback system which plays back the recording medium of FIG. 1;

FIG. 11 is a diagram describing a correction method for the 3D image data;

FIG. 12 is a flowchart describing an image processing of a playback device of FIG. 10;

FIG. 13 is a block diagram illustrating a composition example of a second embodiment of the recording system to which the present invention is applied;

FIG. 14 is a block diagram illustrating a composition example of a playback system which plays back a recording medium of FIG. 13;

FIG. 15 is a flowchart describing an image processing of a playback device of FIG. 14;

FIG. 16 is a block diagram illustrating a composition example of a third embodiment of the recording system to which the present invention is applied;

FIG. 17 is a block diagram illustrating a composition example of a playback system which plays back a recording medium of FIG. 16;

FIG. 18 is a diagram describing a correction of a parallax by a parallax controlling unit of FIG. 17;

FIG. 19 is a flowchart describing an image processing of a playback device of FIG. 17; and

FIG. 20 is a diagram illustrating a composition example of an embodiment of a computer.

### DESCRIPTION OF THE PREFERRED EMBODIMENTS

### First Embodiment

Composition Example of First Embodiment of Recording Device

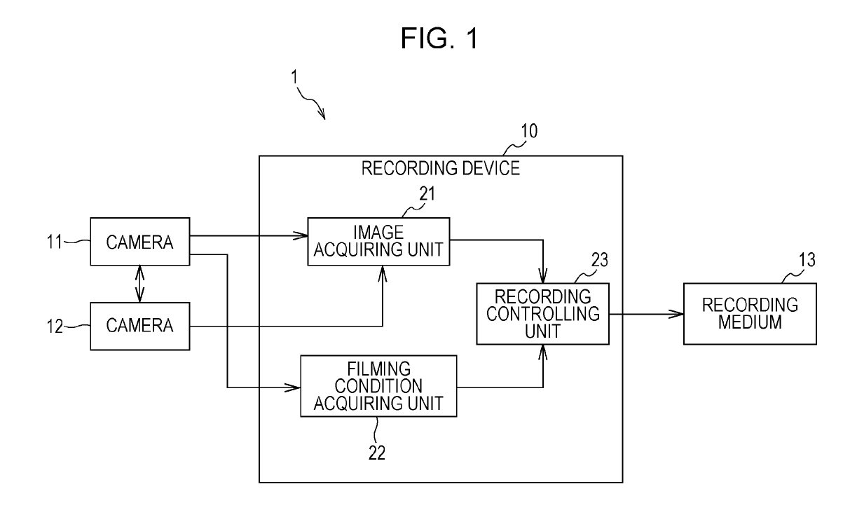

FIG. 1 is a block diagram illustrating a composition example of a first embodiment of a recording system to which the present invention is applied.

The recording system 1 of FIG. 1 is constituted by a camera 11 (a filming device for the left eye), a camera 12 (a filming device for the right eye), and a recording device 10. In the recording system 1, images simultaneously filmed by the camera 11 and the camera 12 are recorded in a recording medium 13 as 3D images.

Specifically, the camera 11 is arranged in a location a predetermined distance apart from the camera 12. The camera 11 is synchronized with the camera 12 and performs filming simultaneously with the camera 12 with the same filming conditions as the camera 12. The camera 11 supplies image data obtained as a result thereof to the recording device 10 as the image data of images for the left eye among 3D images. In addition, the camera 11 supplies the filming condition information which is information indicating the filming conditions during the filming to the recording device 10.

The camera 12 is arranged in a location a predetermined distance apart from the camera 11. The camera 12 is synchronized with the camera 11 and performs filming simultaneously with the camera 11 with the same filming conditions as the camera 11. The camera 12 supplies image data obtained as a result thereof to the recording device 10 as the image data of images for the right eye among 3D images.

Furthermore, herein, the filming condition information is made to be input to the recording device 10 from the camera 11, but the filming condition information may be input to the recording device 10 from at least any one of the camera 11 and the camera 12.

The recording device 10 is constituted by an image acquiring unit 21, a filming condition acquiring unit 22, and a recording controlling unit 23.

The image acquiring unit 21 of the recording device 10 acquires image data for the left eye which are input from the camera 11 and image data for the right eye which are input from the camera 12. The image acquiring unit 21 supplies image data for the left eye and image data for the right eye to the recording controlling unit 23 as the image data of 3D images (hereinafter, referred to as 3D image data).

The filming condition acquiring unit 22 acquires filming condition information which is input from the camera 11 and supplies the information to the recording controlling unit 23.

The recording controlling unit 23 causes the recording medium 13 to be subject to recording by corresponding the 3D image data supplied from the image acquiring unit 21 to the filming condition information supplied from the filming condition acquiring unit 22.

### Description of Filming Condition Information

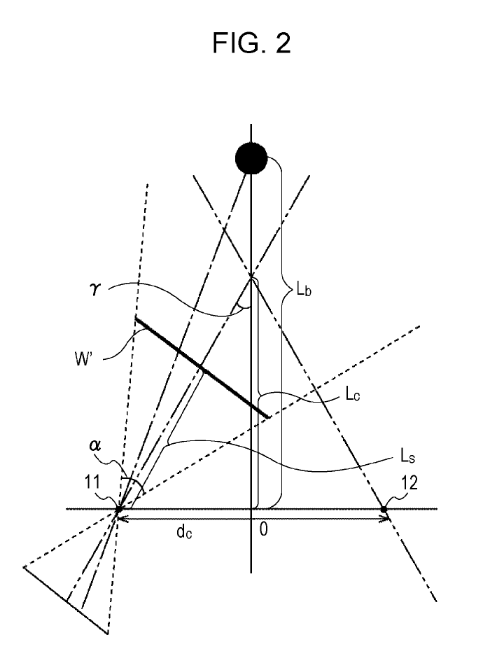

FIGS. 2 to 5 are diagrams describing the filming condition information recorded together with the 3D image data in the recording system 1 of FIG. 1.

FIG. 2 is a diagram illustrating the parameters indicating the filming conditions in the camera 11.

As shown in FIG. 2, there are a camera interval (the distance between the filming devices) d_{c} which is the distance between the camera 11 and the camera 12, an angle of view α of the camera 11, a convergence angle γ, a distance to the optical axes crossing point L_{c}, a filming distance L_{b}, a virtual screen width W′, and the like as parameters indicating the filming conditions in the camera 11.

Furthermore, the convergence angle γ refers to an angle formed with the perpendicular line to the straight line connecting the location of the camera 11 and the location of the camera 12 which passes the crossing point of the optical axis of the camera 11 and the optical axis of the camera 12 and the optical axis of the camera 11.

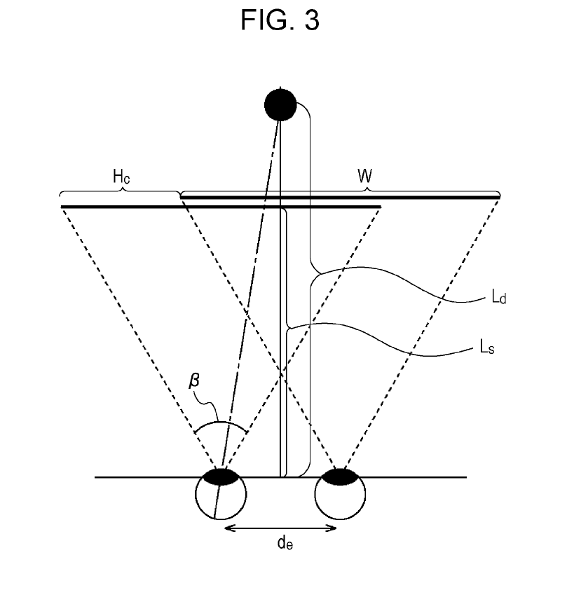

In addition, the distance to the optical axes crossing point L_{c} refers to the distance from the crossing point of the optical axis of the camera 11 and the optical axis of the camera 12 to the straight line connecting the location of the camera 11 and the location of the camera 12. In addition, the filming distance L_{b} refers to the distance from the subject to the straight line connecting the location of the camera 11 and the location of the camera 12. The virtual screen width W′ refers to the width of the plane in the angle of view α, which is perpendicular to the optical axis of the camera 11 and is located a visual distance L_{s (}to be described later in FIG. 3) apart toward the subject.

Furthermore, although omitted in the drawings, the parameters indicating the filming conditions in the camera 12 are the same as those indicating the filming conditions in the camera 11 as the camera 12 is substituted for the camera 11.

FIG. 3 is a diagram illustrating the parameters indicating the display conditions of the 3D image data recorded in the recording medium 13.

As shown in FIG. 3, there are an inter-eye distance dₑ of a viewer, a visual angle β, a visual distance Lₛ, a screen width W, and a parallax H_{c} which is the displacement of the screen for the left eye and the screen for the right eye in the horizontal direction, as parameters indicating the display conditions.

Furthermore, the visual distance Lₛ refers to the distance from a viewer to the display surface in the direction perpendicular to the display surface (hereinafter referred to as the depth direction), and the screen width W is a width of the display surface in the direction of the parallax H_{c}, in other words, the width of the display surface in the horizontal direction.

If such parameters indicating the filming conditions and the display conditions are used, a display distance L_{d} which is the distance from the eyes of a viewer to the 3D images in the depth direction is expressed by Equation (1) given below.

$${L}_{d} = \frac{1}{\frac{1}{{L}_{s}} - \frac{{a}_{1} {a}_{2}}{{L}_{c}} + \frac{{a}_{1} {a}_{2}}{{L}_{b}} - \frac{{H}_{c}}{{L}_{s} {d}_{e}}} \\ {a}_{1} = \frac{{d}_{c}}{{d}_{e}} , {a}_{2} = \frac{W}{{W}^{′}} \qquad ( 1 )$$

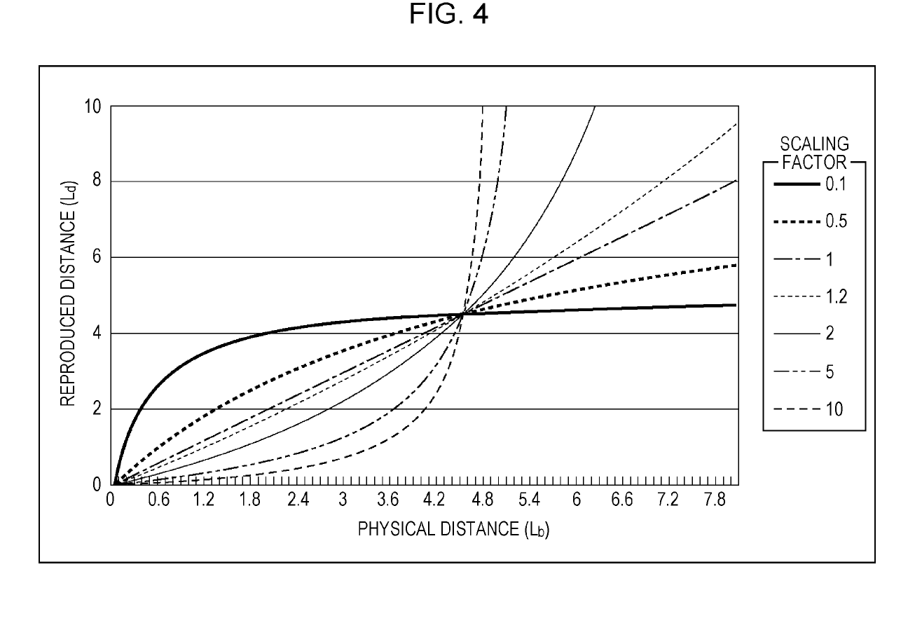

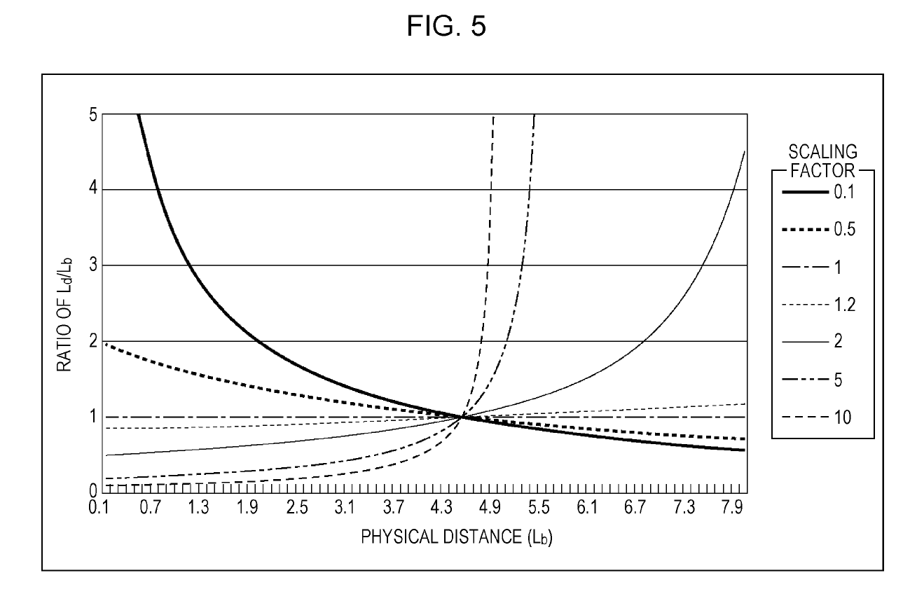

Accordingly, as shown in FIGS. 4 and 5, the screen width W affects the relationship of the filming distance L_{b} and the display distance L_{d}.

Specifically, the horizontal axis of the graph in FIG. 4 indicates the filming distance L_{b} and the vertical axis indicates the display distance L_{d}. In addition, the horizontal axis of the graph in FIG. 5 indicates the filming distance L_{b} and the vertical axis indicates L_{d}/L_{b}. Moreover, various lines on the graphs in FIGS. 4 and 5 indicate cases where an image magnification (Magnification of Image) a₂ is 0.1, 0.5, 1, 1.2, 2, 5, and 10.

As shown in FIGS. 4 and 5, when the image magnification a₂ is 1, in other words, and when the screen width W and the virtual screen width W′ are equal, the filming distance L_{b} and the display distance L_{d} become equal. However, when the image magnification a₂ is not 1, the filming distance L_{b} and the display distance L_{d} become different, and thereby the 3D images displayed appear unnatural.

Thus, the recording device 10 records the camera interval d_{c}, the angle of view α, and the convergence angle γ in the recording medium 13 together with the 3D image data as the filming condition information. Accordingly, as to be described later, even when the image magnification a₂ is not 1, the parallax H_{c} can be corrected in the playback device for playing back the recording medium 13 so that the filming distance L_{b} and the display distance L_{d} are equal. As a result, more natural 3D images can be displayed.

Furthermore, when the parallax H_{c} is greater than the inter-eye distance dₑ, the foci of the left eye and the right eye do not match, and the 3D images are not seen. In addition, the camera interval d_{c} included in the filming condition information is expressed with a length unit (for example, millimeter) herein.

### Description of Processing in Recording Device

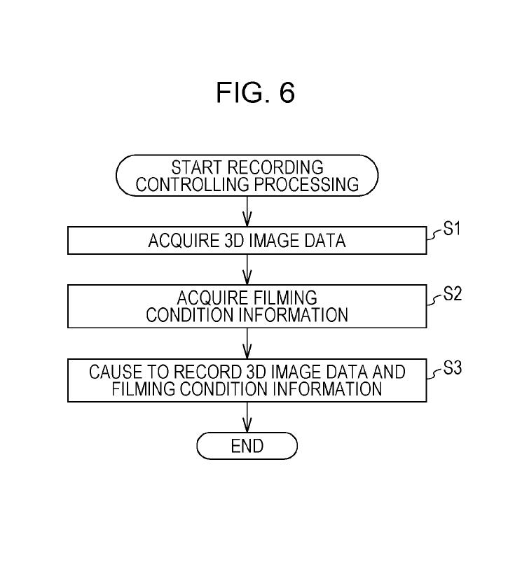

FIG. 6 is a flowchart describing a recording controlling process of the recording device 10. This recording controlling process is started when the image data and the filming condition information are input.

In Step S1, the image acquiring unit 21 acquires image data for the left eye input from the camera 11 and image data for the right eye input from the camera 12 as 3D image data. Then, the image acquiring unit 21 supplies the 3D image data to the recording controlling unit 23.

In Step S2, the filming condition acquiring unit 22 acquires filming condition information input from the camera 11 and supplies the information to the recording controlling unit 23.

In Step S3, the recording controlling unit 23 causes the recording medium 13 to be subject to recording by corresponding the 3D image data supplied from the image acquiring unit 21 to the filming condition information supplied from the filming condition acquiring unit 22, and thereby the process ends.

As above, since the recording device 10 records the filming condition information corresponding to the 3D image data on the recording medium 13, the filming condition information can be provided in correspondence with the 3D image data.

### Composition Example of Playback System

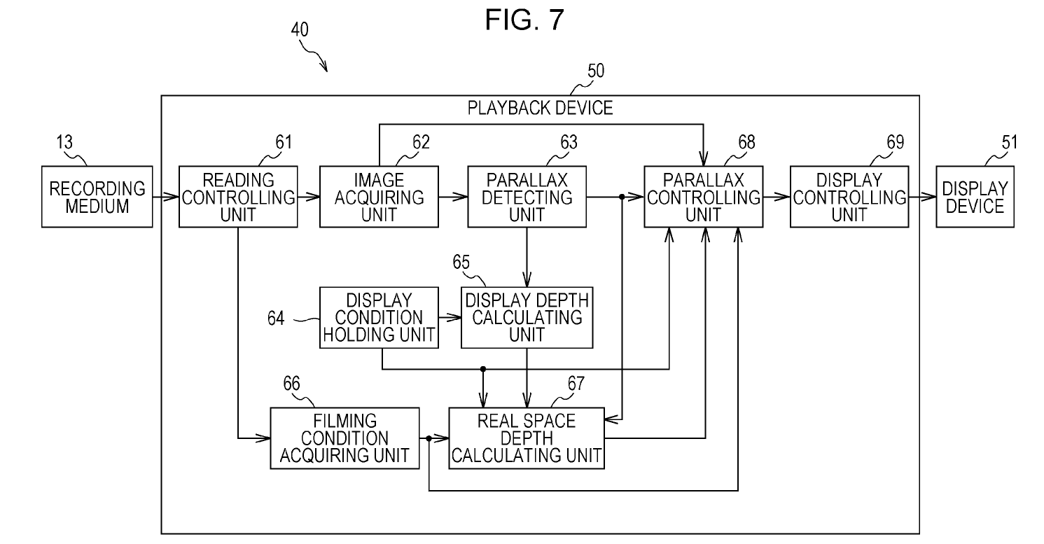

FIG. 7 is a block diagram illustrating a composition example of a playback system which plays back the recording medium 13 of FIG. 1.

A playback system 40 of FIG. 7 is constituted by a playback device (image processing device) 50 and a display device 51. The playback system 40 corrects the parallax H_{c} of the 3D image data based on the filming condition information recorded in the recording medium 13 so that the display distance L_{d} is equal to the filming distance L_{b}, and displays 3D images based on the 3D image data after the correction.

Specifically, the playback device 50 is constituted by a reading controlling unit 61, an image acquiring unit 62, a parallax detecting unit 63, a display condition holding unit 64, a display depth calculating unit (display distance calculator) 65, a filming condition acquiring unit 66, a real space depth calculating unit (filming distance calculator) 67, a parallax controlling unit 68, and a display controlling unit 69.

The reading controlling unit 61 reads the 3D image data from the recording medium 13 and the filming condition information corresponding thereto. The reading controlling unit 61 supplies the 3D image data to the image acquiring unit 62, and the filming condition information to the filming condition acquiring unit 66.

The image acquiring unit 62 acquires the 3D image data supplied from the reading controlling unit 61 and supplies the data to the parallax detecting unit 63 and the parallax controlling unit 68.

The parallax detecting unit 63 detects parallax for every predetermined unit such as a pixel based on the 3D image data supplied from the image acquiring unit 62 and generates a parallax map which expresses the parallax in a pixel unit. The parallax detecting unit 63 supplies the parallax map to the display depth calculating unit 65, the real space depth calculating unit 67, and the parallax controlling unit 68.

The display condition holding unit 64 holds the visual distance Lₛ, the inter-eye distance dₑ, the screen width W and the dot pitch of the display device 51 as the display condition information which is information indicating the display conditions of the 3D images. Moreover, the display condition information is assumed to be expressed by a unit of length (for example, millimeter). Furthermore, the display condition information may be set in advance, set by the input by a user, or detected by a detection device not shown in the drawing. The display condition holding unit 64 supplies the display condition information held to the display depth calculating unit 65, the real space depth calculating unit 67, and the parallax controlling unit 68.

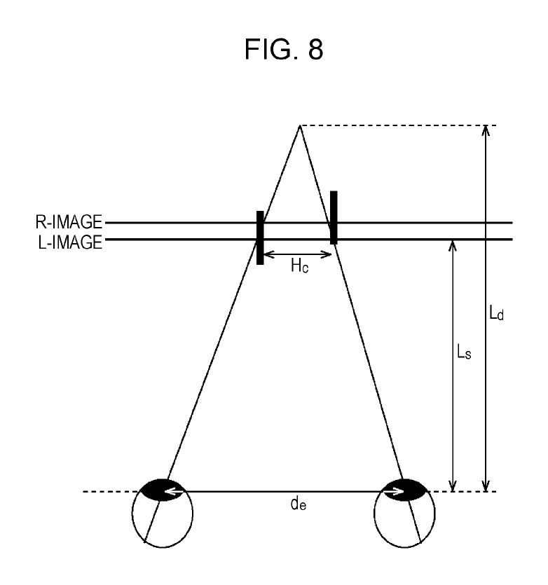

The display depth calculating unit 65 calculates the display distance L_{d} of the displaying time of the 3D images based on the 3D image data recorded in the recording medium 13 by using the parallax map from the parallax detecting unit 63 and the display condition information from the display condition holding unit 64. This calculating method will be explained with reference to FIG. 8 described below. The display depth calculating unit 65 supplies the calculated display distance L_{d} to the real space depth calculating unit 67.

The filming condition acquiring unit 66 acquires the filming condition information supplied from the reading controlling unit 61 and supplies the information to the real space depth calculating unit 67 and the parallax controlling unit 68.

The real space depth calculating unit 67 performs an arithmetic operation with the Equation (1) by using the parallax map from the parallax detecting unit 63, the display condition information from the display condition holding unit 64, the display distance L_{d} from the display depth calculating unit 65, and the filming condition information from the filming condition acquiring unit 66, thereby obtaining the filming distance L_{b}.

Specifically, the real space depth calculating unit 67 calculates the ratio of a camera interval (Camera Separation Ratio) a₁ by using the camera interval d_{c} included in the filming condition information and the inter-eye distance dₑ included in the display condition information. In addition, the real space depth calculating unit 67 calculates the distance to the optical axes crossing point L_{c} by using the convergence angle γ and the camera interval d_{c} included in the filming condition information. Furthermore, the real space depth calculating unit 67 calculates the virtual screen width W′ by using the angle of view α included in the filming condition information and the visual distance Lₛ included in the display condition information, and calculates the image magnification a₂ by using the virtual screen width W′ and the screen width W included in the display condition information. Moreover, the real space depth calculating unit 67 multiplies a parallax in the pixel unit expressed by the parallax map by the dot pitch of the display device 51, thereby obtaining the parallax H_{c} in the length unit.

Then, the real space depth calculating unit 67 performs an arithmetic operation with Equation (1) by using the display distance L_{d}, the visual distance Lₛ included in the display condition information, the inter-eye distance dₑ, the calculated camera separation ratio a₁, the image magnification a₂, the distance to the optical axes crossing point L_{c}, and the parallax H_{c}. As a result, the real space depth calculating unit 67 obtains the filming distance L_{b}. The real space depth calculating unit 67 supplies the filming distance L_{b} to the parallax controlling unit 68.

The parallax controlling unit 68 obtains a correction amount of the parallax H_{c} in the pixel unit to make the display distance L_{d} equal to the filming distance L_{b} based on the parallax map from the parallax detecting unit 63, the display condition information from the display condition holding unit 64, the filming condition information from the filming condition acquiring unit 66, and the filming distance L_{b} from the real space depth calculating unit 67.

Specifically, the parallax controlling unit 68 calculates the camera separation ratio a₁, the image magnification a₂, and the distance to the optical axes crossing point L_{c} by using the filming condition information and the display condition information in the same manner as the real space depth calculating unit 67. In addition, the parallax controlling unit 68 adopts the display distance L_{d} as the filming distance L_{b} from the real space depth calculating unit 67. Then, the parallax controlling unit 68 performs an arithmetic operation with Equation (1) by using the display distance L_{d}, the filming distance L_{b} from the real space depth calculating unit 67, the visual distance Lₛ included in the display condition information, the inter-eye distance dₑ, the calculated camera separation ratio a₁, the image magnification a₂, and the distance to the optical axes crossing point L_{c}. As a result, the parallax controlling unit 68 obtains the parallax H_{c} for making the display distance L_{d} equal to the filming distance L_{b}. Then, the parallax controlling unit 68 has the difference of the parallax H_{c} in the pixel unit obtained by dividing the dot pitch of the display device 51 by the parallax H_{c} in the length unit and the parallax H_{c} in the pixel unit expressed by the parallax map as the correction amount of the parallax H_{c} in the pixel unit.

The parallax controlling unit 68 corrects the parallax H_{c} of the 3D image data supplied from the image acquiring unit 62 based on the correction amount of the parallax H_{c} in the pixel unit. Specifically, the parallax controlling unit 68 displaces the interval between the display locations of the image data for the left eye and the image data for the right eye to the extent of the correction amount of the parallax H_{c}. The parallax controlling unit 68 supplies the 3D image data that have undergone the correction to the display controlling unit 69.

The display controlling unit 69 causes the display device 51 to display 3D images based on the 3D image data supplied from the parallax controlling unit 68. Specifically, the display controlling unit 69 causes the display device 51 to alternately display images for the left eye corresponding to the image data for the left eye and images for the right eye corresponding to the image data for the right eye, the both of which constitute the 3D image data. At this moment, a user wears, for example, an eyeglass with a shutter which is synchronized with the shifting of the images for the left eye and the images for the right eye and sees the images for the left eye only with the left eye and the images for the right eye only with the right eye. Thereby, the user can see the 3D images.

### Description of Calculation Method of Display Distance

FIG. 8 is a diagram describing a calculation method of the display distance L_{d} in the display depth calculating unit 65 of FIG. 7.

As shown in FIG. 8, the ratio of the difference between the display distance L_{d} and the visual distance Lₛ to the display distance L_{d} is equal to the ratio of the parallax H_{c} to the inter-eye distance dₑ. Therefore, the display depth calculating unit 65 performs an arithmetic operation with Equation (2) by using the visual distance Lₛ included in the display condition information, the inter-eye distance dₑ, and the parallax H_{c} in the length unit obtained by multiplying the parallax in the pixel unit from the parallax detecting unit 63 expressed by the parallax map by the dot pitch of the display device 51, thereby calculating the display distance L_{d}.

$${L}_{d} = \frac{{d}_{e} {L}_{s}}{{d}_{e} - {H}_{c}} \qquad ( 2 )$$

### Description of Processing by Playback Device

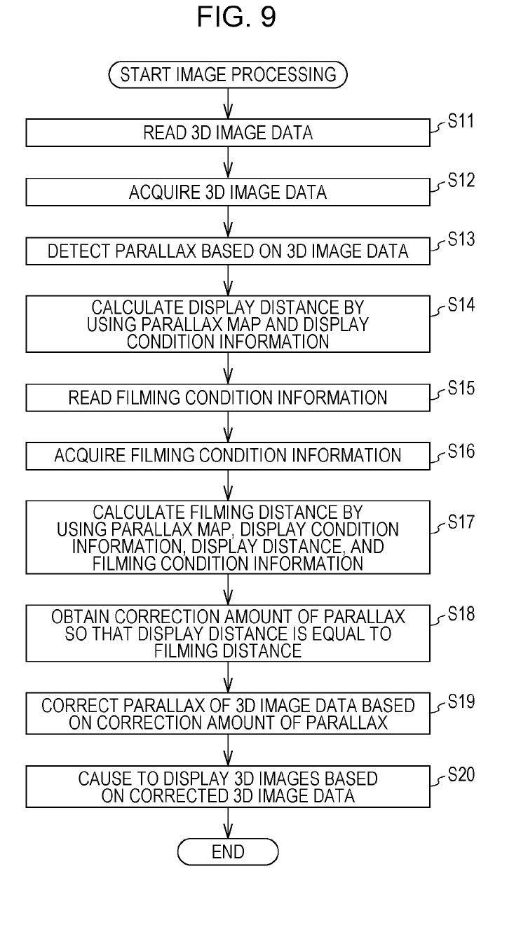

FIG. 9 is a flowchart describing an image processing of a playback device 50 of FIG. 7. The playback device 50 is started, for example, when a user commands the playback of the 3D image data recorded in the recording medium 13.

In Step S11, the reading controlling unit 61 reads the 3D image data from the recording medium 13 and supplies the 3D image data to the image acquiring unit 62.

In Step S12, the image acquiring unit 62 acquires the 3D image data supplied from the reading controlling unit 61 and supplies the data to the parallax detecting unit 63 and the parallax controlling unit 68.

In Step S13, the parallax detecting unit 63 detects the parallax for every predetermined unit such as a pixel or the like based on the 3D image data supplied from the image acquiring unit 62 and generates a parallax map which expresses the parallax in a pixel unit. The parallax detecting unit 63 supplies the parallax map to the display depth calculating unit 65, the real space depth calculating unit 67, and the parallax controlling unit 68.

In Step S14, the display depth calculating unit 65 performs an arithmetic operation with Equation (2) by using the parallax H_{c} in the length unit obtained by multiplying the parallax expressed by the parallax map from the parallax detecting unit 63 by the dot pitch of the display device 51, and the visual distance Lₛ and the inter-eye distance dₑ from the display condition holding unit 64 which are included in the display condition information, thereby obtaining the display distance L_{d}. The display depth calculating unit 65 supplies the calculated display distance L_{d} to the real space depth calculating unit 67.

In Step S15, the reading controlling unit 61 reads the filming condition information recorded in the recording medium 13 in correspondence with the 3D image data read in Step S11. The reading controlling unit 61 supplies the filming condition information to the filming condition acquiring unit 66.

In Step S16, the filming condition acquiring unit 66 acquires the filming condition information supplied from the reading controlling unit 61 and supplies the information to the real space depth calculating unit 67 and the parallax controlling unit 68.

In Step S17, the real space depth calculating unit 67 performs an arithmetic operation with Equation (1) by using the parallax map from the parallax detecting unit 63, the display condition information from the display condition holding unit 64, the display distance L_{d} from the display depth calculating unit 65, and the filming condition information from the filming condition acquiring unit 66, thereby calculating the filming distance L_{b}, that is, the depth location of the subject in the real space. Then, the real space depth calculating unit 67 supplies the filming distance L_{b} to the parallax controlling unit 68.

In Step S18, the parallax controlling unit 68 obtains the correction amount of the parallax H_{c} in the pixel unit for making the display distance L_{d} equal to the filming distance L_{b} based on the parallax map from the parallax detecting unit 63, the display condition information from the display condition holding unit 64, the filming condition information from the filming condition acquiring unit 66, and the filming distance L_{b} from the real space depth calculating unit 67.

In Step S19, the parallax controlling unit 68 corrects the parallax H_{c} of the 3D image data supplied from the image acquiring unit 62 based on the correction amount of the parallax H_{c} in the pixel unit and supplies the data to the display controlling unit 69.

In Step S20, the display controlling unit 69 displays 3D images in the display device 51 based on the corrected 3D image data supplied from the parallax controlling unit 68, and thereby the process ends.

As above, since the playback device 50 performs correction of the parallax of the 3D image data corresponding to the filming condition information based on the display condition information and the filming condition information read from the recording medium 13, more natural 3D images can be displayed even when the screen width W is not equal to the virtual screen width W′.

Particularly, the parallax of the 3D image data is corrected so that the display distance L_{d} is equal to the filming distance L_{b}, the playback device 50 can display natural 3D images closer to the subject in the real space.

### Another Composition Example of Playback System

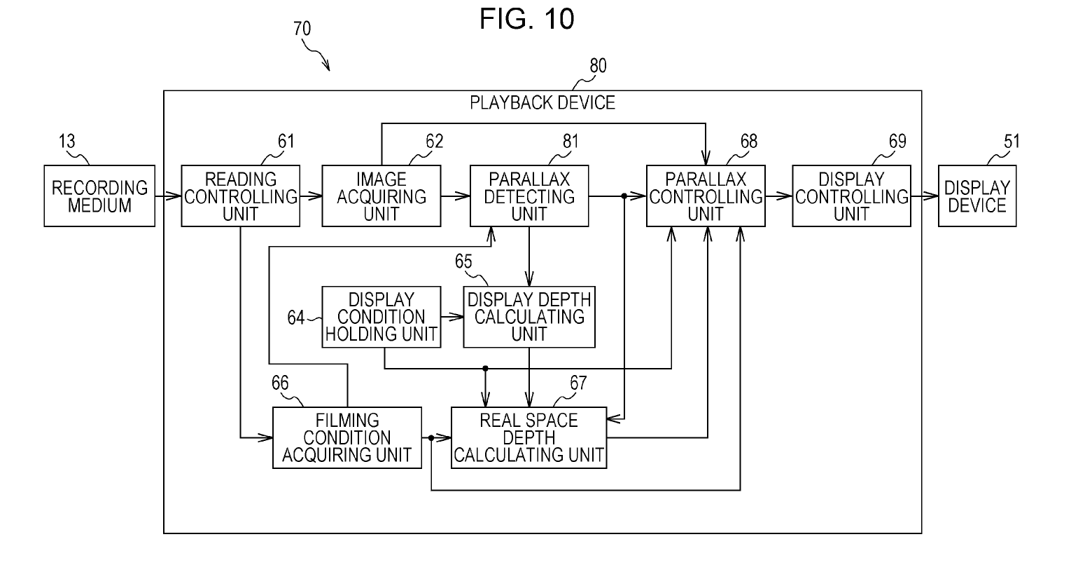

FIG. 10 is a block diagram illustrating another composition example of the playback system which plays back the recording medium 13 of FIG. 1.

The same compositional elements of FIG. 7 as those of FIG. 10 are given with the same reference numerals. Overlapping descriptions will be omitted as appropriate.

The main difference in the composition of a playback system 70 of FIG. 10 from that of FIG. 7 is that a playback device 80 is provided having a parallax detecting unit 81 instead of the parallax detecting unit 63 of the playback device 50 in FIG. 7. In the playback device 80 of FIG. 10, the parallax detecting unit 81 corrects 3D image data based on the filming condition information and generates a parallax map based on the corrected 3D image data.

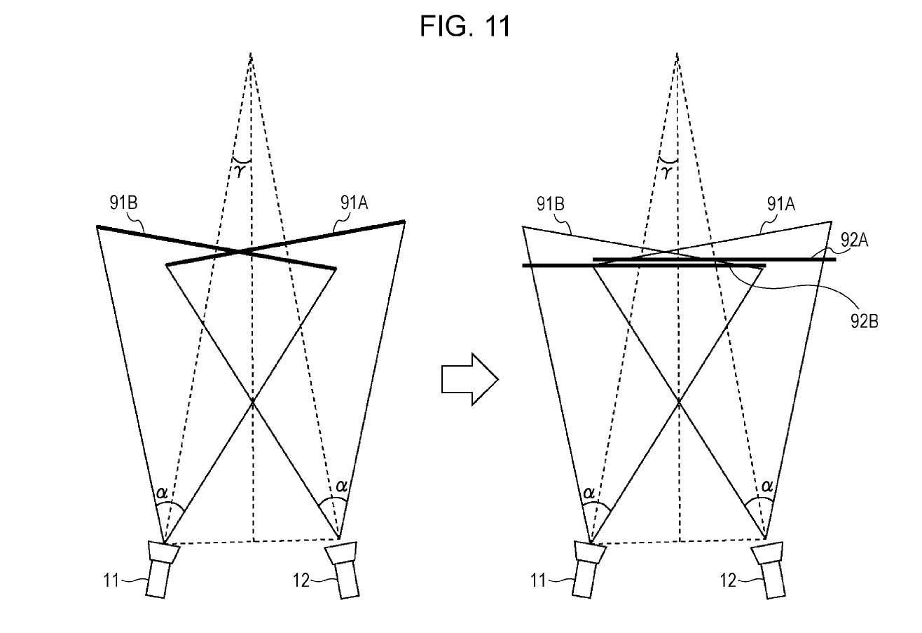

Specifically, the filming condition information is supplied to the parallax detecting unit 81 from the filming condition acquiring unit 66. The parallax detecting unit 81 corrects the 3D image data supplied from the image acquiring unit 62 based on the filming conditions. The correcting method will be explained in detail with reference to FIG. 11 described later. The parallax detecting unit 81 detects the parallax for every predetermined unit such as a pixel or the like based on the corrected 3D image data, and generates a parallax map which expresses the parallax in the pixel unit. The parallax detecting unit 81 supplies the parallax map to the display depth calculating unit 65, the real space depth calculating unit 67, and the parallax controlling unit 68 in the same manner as the parallax detecting unit 63 of FIG. 7.

### Description of Correction Method for 3D Image Data

FIG. 11 is a diagram describing a correction method for 3D image data in the parallax detecting unit 81 of FIG. 10.

As shown in FIG. 11, the parallax detecting unit 81 performs trapezoid correction for the 3D image data based on the convergence angle γ and the angle of view α when the convergence angle γ included in the filming condition information is not 0, in other words, when 3D images are seen in the crossing method. Specifically, the parallax detecting unit 81 corrects an image for the right eye 91A based on the convergence angle γ and the angle of view α so that the inclination of the image for the right eye 91A, which corresponds to the image data for the right eye constituting the 3D image data, to the straight line connecting the location of the camera 11 and the location of the camera 12 is 0, and the corrected image is an image for the right eye 92A. In the same manner, the parallax detecting unit 81 corrects an image for the left eye 91B based on the convergence angle γ and the angle of view α so that the inclination of the image for the left eye 91B, which corresponds to the image data for the left eye, to the straight line connecting the location of the camera 11 and the location of the camera 12 is 0, and the corrected image is an image for the left eye 92B.

By performing trapezoid correction as described above, the inclination of the image for the right eye 92A and the inclination of the image for the left eye 92B to the straight line connecting the location of the camera 11 and the location of the camera 12 are equal to each other, and the matching accuracy of the image for the right eye 92A and the image for the left eye 92B is improved. As a result, the accuracy of parallax detection enhances.

### Description of Processing by Playback Device

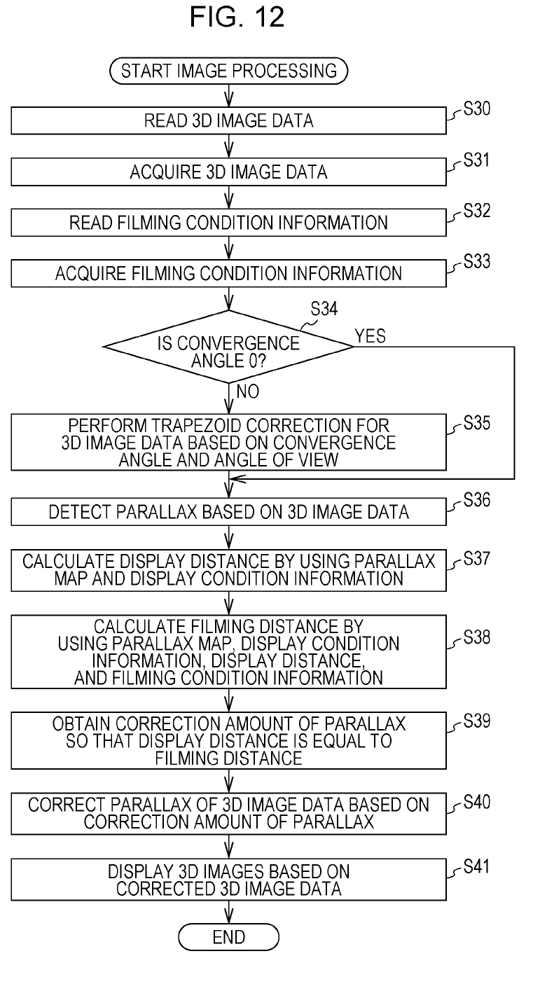

FIG. 12 is a flowchart describing an image processing of the playback device 80 of FIG. 10. The playback device 80 is started, for example, when a user commands the playback of the 3D image data recorded in the recording medium 13.

Since the processes in Steps S30 and S31 are the same as those in Steps S11 and S12 of FIG. 9, and the processes in Steps S32 and S33 are the same as those in Steps S15 and S16 of FIG. 9, description thereof will not be repeated.

After the process in Step S33, the parallax detecting unit 81 determines whether or not the convergence angle γ included in the filming condition information supplied from the filming condition acquiring unit 66 is 0 in Step S34. When it is determined that the convergence angle γ is not 0 in Step S34, the parallax detecting unit 81 performs trapezoid correction for the 3D image data supplied from the image acquiring unit 62 based on the convergence angle γ and the angle of view α in Step S35, and the process advances to Step S36.

On the other hand, when it is determined that the convergence angle γ is 0 in Step S34, the process of Step S35 is skipped and then advances to Step S36.

In Step S36, the parallax detecting unit 81 detects the parallax for every predetermined unit such as a pixel or the like based on the 3D image data that have been subject to the trapezoid correction in the process of Step S35 and the 3D image data that have not been subject to the process of Step S35, and generates a parallax map which expresses the parallax in the pixel unit. Then, the parallax detecting unit 81 supplies the parallax map to the display depth calculating unit 65, the real space depth calculating unit 67, and the parallax controlling unit 68, and the process advances to Step S37.

Since the processes from Steps S37 to S41 are the same as those in Step S14 and Steps S17 to S20 of FIG. 9, description thereof will not be repeated.

### Second Embodiment

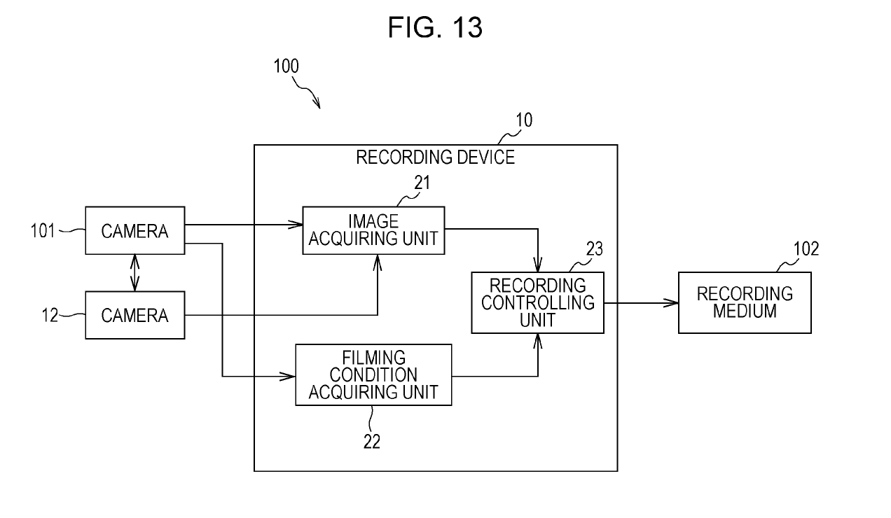

FIG. 13 is a block diagram illustrating a composition example of a second embodiment of the recording system to which the present invention is applied.

The same compositional elements of FIG. 13 as those of FIG. 1 are given with the same reference numerals.

### Overlapping Descriptions Will be Omitted as Appropriate.

The composition of a recording system 100 of FIG. 13 is different from that of FIG. 1 mainly in that a camera 101 is provided instead of the camera 11. In the recording system 100 of FIG. 13, the camera 101 inputs to the recording device 10 information pertaining to the filming distance L_{b} (hereinafter, referred to as the filming distance information) in addition to the camera interval d_{c}, the angle of view α, and the convergence angle γ as the filming condition information, and a recording medium 102 is recorded with the filming condition information therein.

Specifically, the camera 101 is arranged in a location a predetermined distance apart from the camera 12 as the camera 11 of FIG. 1. The camera 101 is synchronized with the camera 12 and performs filming simultaneously with the camera 12 under the same filming condition as that of the camera 12 in the same manner as the camera 11. The camera 101 supplies the image data resulting therefrom to the recording device 10 as the image data for the left eye in the same manner as the camera 11. In addition, the camera 101 supplies the recording device 10 with the camera interval d_{c}, angle of view α, convergence angle γ, and the filming distance information as the filming condition information.

Furthermore, there is at least one of the focal length or the zoom factor of the camera 101 as the filming distance information. In addition, the filming condition information is designed to be input to the recording device 10 from the camera 101 herein, but when the filming condition information is input to the recording device 10 from the camera 12, at least one of the focal length or the zoom factor of the camera 12 is used as the filming distance information. Moreover, the focal length is to be expressed in a unit of length (for example, millimeter) herein.

### Composition Example of Playback System

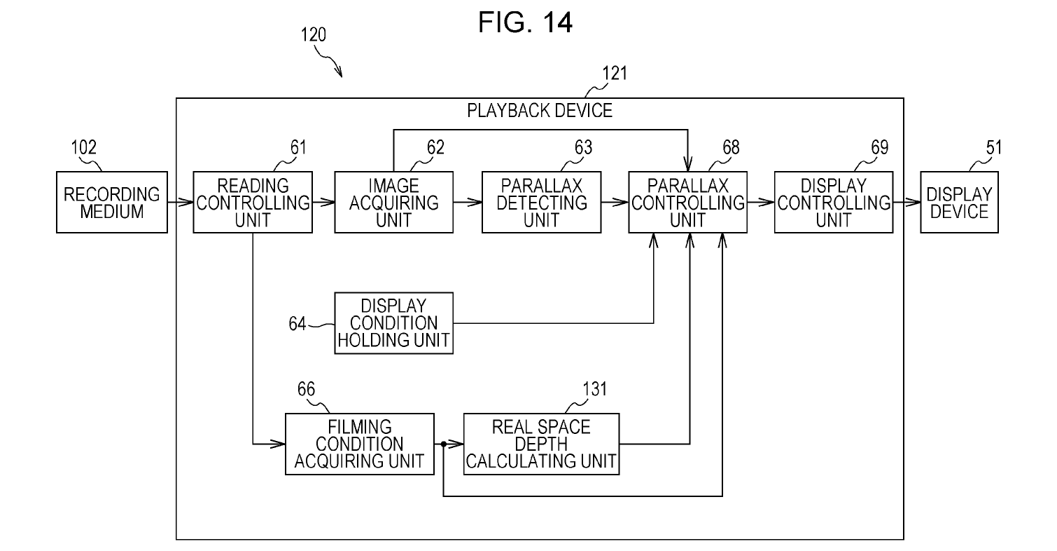

FIG. 14 is a block diagram illustrating a composition example of a playback system which plays back a recording medium 102 of FIG. 13.

The same compositional elements of FIG. 14 as those of FIG. 7 are given with the same reference numerals. Overlapping descriptions will be omitted as appropriate.

The composition of a playback system 120 of FIG. 14 is different from that of FIG. 7 mainly in that a playback device 121 is provided instead of the playback device 50. With regard to the playback system 120 of FIG. 14, the filming distance L_{b} is obtained by using the filming distance information in the playback device 121 and the parallax H_{c} of the 3D image data is corrected so that the filming distance L_{b} is equal to the display distance L_{d}.

Specifically, the playback device 121 includes the reading controlling unit 61, the image acquiring unit 62, the parallax detecting unit 63, the display condition holding unit 64, the filming condition acquiring unit 66, the parallax controlling unit 68, the display controlling unit 69, and a real space depth calculating unit 131.

The real space depth calculating unit 131 of the playback device 121 calculates the filming distance L_{b} by using the filming distance information included in the filming condition information supplied from the filming condition acquiring unit 66 and supplies the value to the parallax controlling unit 68.

### Description of Processing of Playback Device

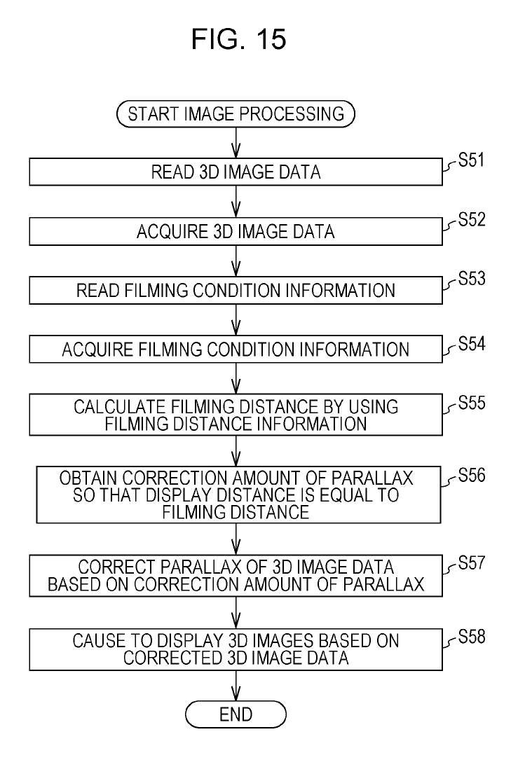

FIG. 15 is a flowchart describing an image processing of the playback device 121 of FIG. 14. The playback device 121 is started, for example, when a user commands the playback of the 3D image data recorded in the recording medium 102.

Since processes from Steps S51 to S54 of FIG. 15 are the same as those in Steps S11, S12, S15, and S16 of FIG. 9, description thereof will not be repeated.

After the process of Step S54, the real space depth calculating unit 131 calculates the filming distance L_{b} by using the filming distance information included in the filming condition information supplied from the filming condition acquiring unit 66 in Step S55 and supplies the value to the parallax controlling unit 68. Then, the process advances to Step S56.

Since the processes from Steps S56 to S58 are the same as those in Steps S18 to S20 of FIG. 9, description thereof will not be repeated.

As above, since the recording medium 102 is recorded with the filming distance information as the filming condition information, the playback device 121 can easily obtain the filming distance L_{b} without having to calculate the display distance L_{d} in order to calculate the filming distance L_{b}.

Furthermore, in the first and second embodiments, the angle of view α is included in the filming condition information, but the focal length L_{f} expressed in the length unit (for example, millimeter) and the frame size S of the camera 11 (or 12 or 101) may be included therein instead of the angle of view α. In that case, the playback device 50 (or 121) obtains the angle of view α from the focal length L_{f} and the frame size S based on the relationship of Equation (3) given below, and uses the value in the same manner as the angle of view α included in the above-described filming condition information.

$$2 tan \frac{α}{2} = \frac{S}{{L}_{f}} \qquad ( 3 )$$

Furthermore, the frame size S may be expressed in the pixel unit, not in the length unit. In other words, the frame size S may be the number of pixels of a sensor in the camera 11 (or 12 or 101). In that case, the filming condition information further includes the dot pitch of the sensor in the camera 11 (or 12 or 101), and the value obtained by multiplying the frame size S in the pixel unit by the dot pitch of the sensor in the camera 11 (or 12 or 101) is used as the frame size S of Equation (3).

### Third Embodiment

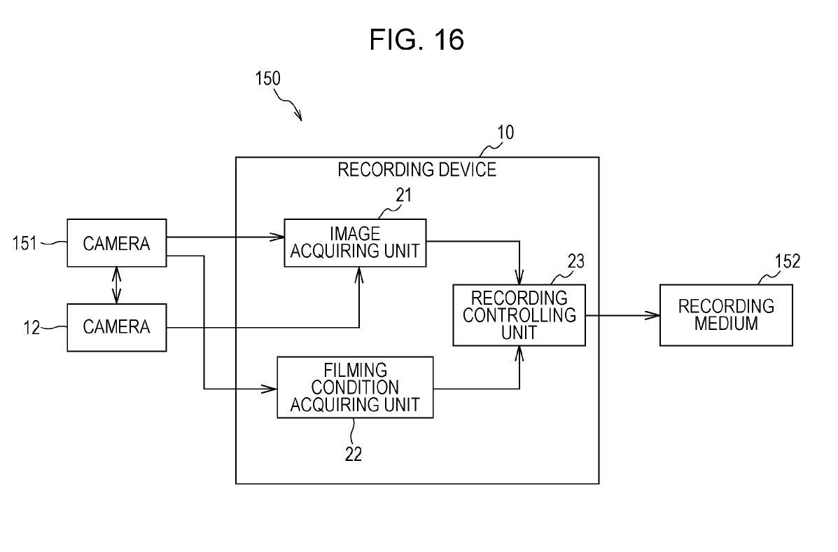

FIG. 16 is a block diagram illustrating a composition example of a third embodiment of the recording system to which the present invention is applied.

The same compositional elements of FIG. 16 as those of FIG. 1 are given with the same reference numerals. Overlapping descriptions will be omitted as appropriate.

The composition of a recording system 150 of FIG. 16 is different from that of FIG. 1 mainly in that a camera 151 is provided instead of the camera 11. With respect to the recording system 150 of FIG. 16, the camera 151 inputs to the recording device 10 the camera interval d_{c} and the convergence angle γ as the filming condition information, and the recording medium 152 is recorded with the filming condition information.

Specifically, the camera 151 is arranged in a location a predetermined distance apart from the camera 12 as the camera 11 of FIG. 1. The camera 151 is synchronized with the camera 12 and performs the filming simultaneously with the camera 12 under the same filming condition as that of the camera 12 in the same manner as the camera 11. The camera 151 supplies the image data resulting therefrom to the recording device 10 as the image data for the left eye in the same manner as the camera 11. In addition, the camera 151 supplies the recording device 10 with the camera interval d_{c} and convergence angle γ as the filming condition information.

### Composition Example of Playback System

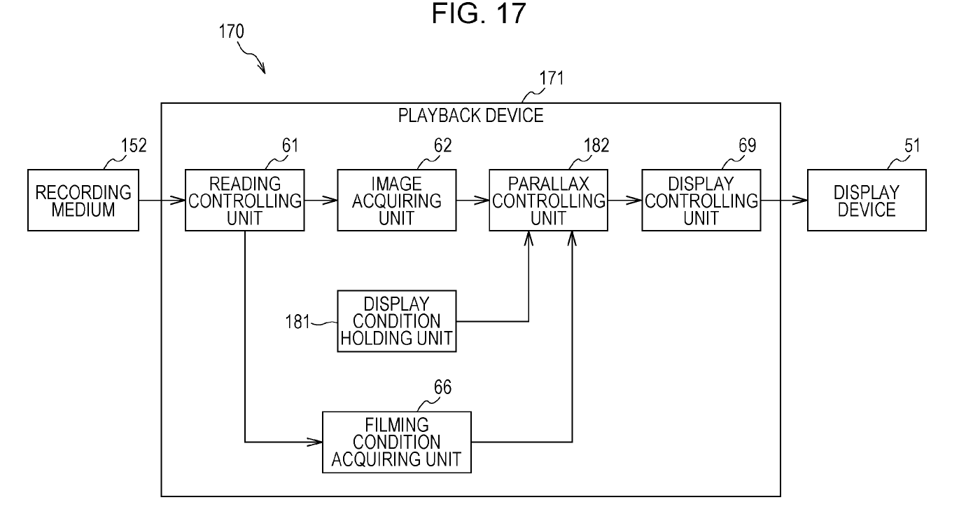

FIG. 17 is a block diagram illustrating a composition example of the playback system which plays back the recording medium 152 of FIG. 16.

The same compositional elements of FIG. 17 as those of FIG. 7 are given with the same reference numerals. Overlapping descriptions will be omitted as appropriate.

The composition of the playback system 170 of FIG. 17 is different from that of FIG. 7 mainly in that a playback device 171 is provided instead of the playback device 50. In the playback system 170 of FIG. 17, the parallax H_{c} of the 3D image data is corrected according to the number of pixels corresponding to the difference between the camera interval d_{c} and the inter-eye distance dₑ recorded in the recording medium 152 as the filming condition information.

Specifically, the playback device 171 includes the reading controlling unit 61, the image acquiring unit 62, the filming condition acquiring unit 66, the display controlling unit 69, the display condition holding unit 181, and the parallax controlling unit 182.

The display condition holding unit 181 of the playback device 171 holds the inter-eye distance dₑ and the dot pitch of the display device 51 as the display condition information. The display condition holding unit 181 supplies the held display condition information to the parallax controlling unit 182.

The parallax controlling unit 182 obtains the correction amount of the parallax H_{c} of the 3D image data supplied from the image acquiring unit 62 in the pixel unit based on the display condition information from the display condition holding unit 181 and the filming condition information from the filming condition acquiring unit 66.

Specifically, the parallax controlling unit 182 obtains the difference by subtracting the camera interval d_{c} included in the filming condition information from the inter-eye distance dₑ included in the display condition information (dₑ-d_{c}) when the convergence angle γ included in the filming condition information is 0, in other words, when the 3D images are seen in a parallel method, and the dot pitch of the display device 51 included in the display condition information is divided by the difference (dₑ-d_{c}). Then, the parallax controlling unit 182 has the number of pixels resulting therefrom as the correction amount of the parallax H_{c}.

In addition, the parallax controlling unit 182 corrects the parallax H_{c} of the 3D image data supplied from the image acquiring unit 62 based on the correction amount of the parallax H_{c} in the pixel unit. The parallax controlling unit 182 supplies the corrected 3D image data to the display controlling unit 69.

### Description of Correction of Parallax

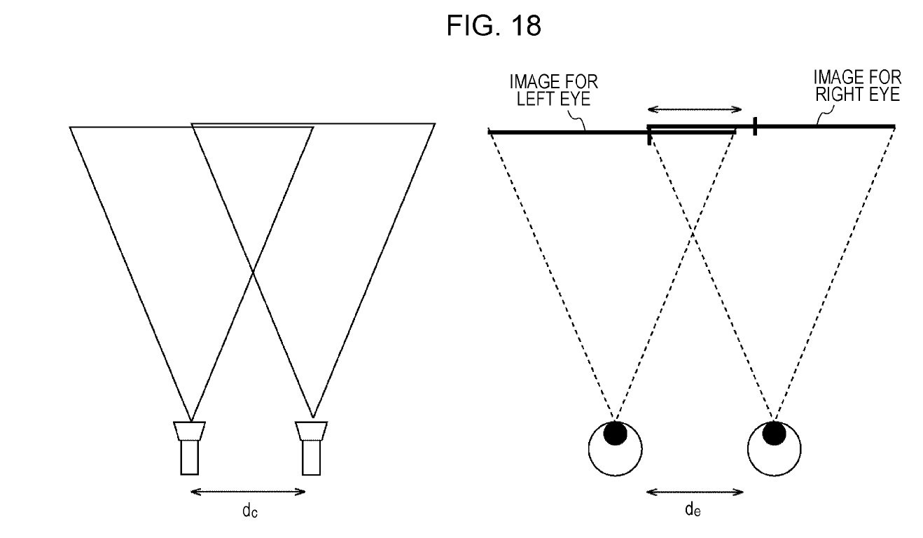

FIG. 18 is a diagram describing the correction of parallax by the parallax controlling unit 182 of FIG. 17.

As shown in FIG. 18, when the convergence angle γ is 0, the parallax controlling unit 182 displaces the interval of display locations of the image data for the left eye and the image data for the right eye according to the number of pixels corresponding to the difference (dₑ-d_{c}) which is the correction amount of the parallax H_{c}.

Accordingly, more natural 3D images can be displayed. On the other hand, when the correction of the parallax H_{c} is not performed, the display distance L_{d} of the overall 3D images is shorter or longer than the filming distance L_{b}. In other words, the overall 3D image projects or recedes unnaturally.

### Description of Processing of Playback Device

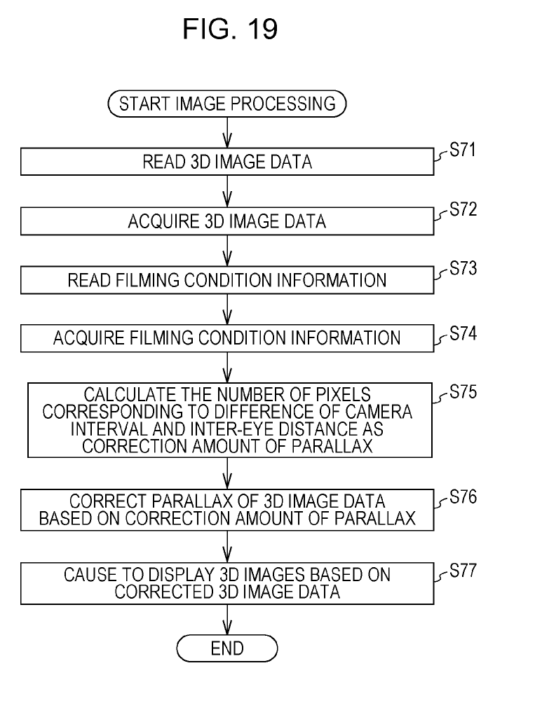

FIG. 19 is a flowchart describing an image processing of the playback device 171 of FIG. 17. The playback device 171 is started, for example, when a user commands the playback of the 3D image data recorded in the recording medium 152.

Since the processes of Steps S71 to S74 of FIG. 19 are the same as those of Steps S11, S12, S15, and S16 of FIG. 9, description thereof will not be repeated.

After the process of Step S74, the parallax controlling unit 182 obtains the number of pixels corresponding to the difference (dₑ-d_{c}) between the camera interval d_{c} and the inter-eye distance dₑ as the correction amount of the parallax H_{c} based on the display condition information from the display condition holding unit 181 and the filming condition information from the filming condition acquiring unit 66 in Step S75.

Since the processes of Steps S76 and S77 are the same as those of Steps S19 and S20 of FIG. 9, description thereof will not be repeated.

Furthermore, in this embodiment, the camera interval d_{c} is assumed to be expressed in the length unit, but the camera interval d_{c} may be expressed in the pixel unit. In that case, for example, the filming condition information further includes the dot pitch of a sensor in the camera 11 (or 12, 101, or 151), and the value obtained by multiplying the camera interval d_{c} in the pixel unit by the dot pitch of the camera sensor may be used as the camera interval d_{c} in the description above. For example, in the third embodiment, the correction amount of the parallax H_{c} can be obtained by having a difference in the length unit by subtracting a value obtained by multiplying the camera interval d_{c} in the pixel unit by the dot pitch of the camera sensor from the inter-eye distance dₑ, and then dividing this difference by the dot pitch of the display device 51.

Furthermore, the present invention can be applied not only to playback devices which play back recording media but also to image processing devices which receive filming condition information and 3D image data played back from a recording medium.

Description of Computer to which the Present Invention is Applied

Next, a series of processes of the above-described recording device and playback device can be performed by hardware and software. When a series of processes is performed by software, a program constituting the software is installed in a general computer or the like.

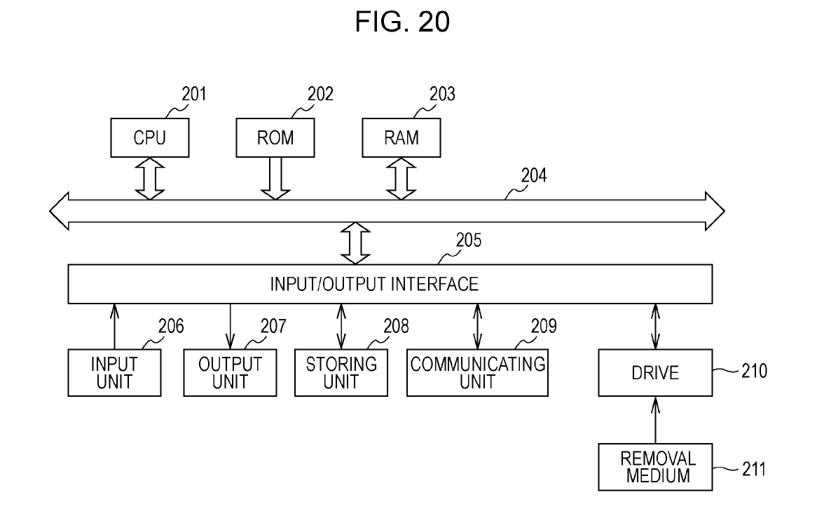

Thus, FIG. 20 shows a composition example of an embodiment of a computer in which a program for performing a series of processing of the above-described recording device and playback device is installed.

The program can be recorded in advance in a storing unit 208 or a ROM (Read Only Memory) 202 as a recording medium built in a computer.

Or in addition to that, the program can be stored (recorded) in a removable medium 211. Such a removable medium 211 can be provided as so-called package software. The removable medium 211 may be, for example, a flexible disc, a CD-ROM (Compact Disc Read Only Memory), an MO (Magneto Optical) disc, a DVD (Digital Versatile Disc), a magnetic disc, a semiconductor memory or the like.

Furthermore, in addition to being installed in the computer via a drive 210 from the removable medium 211 as described above, the program can be downloaded onto the computer via a communication network or broadcasting network and installed in the storing unit 208 built therein. In other words, the program can be transmitted to the computer wirelessly, for example, from a download site via a space satellite for digital satellite broadcasting or to the computer with wire via a network such as a LAN (Local Area Network), or the Internet.

The computer includes a CPU (Central Processing Unit) 201 and the CPU 201 is connected to an input/output interface 205 via a bus 204.

When a user inputs a command by operating an input unit 206 or the like via the input/output interface 205, the CPU 201 executes the program stored in the ROM 202 accordingly. Or, the CPU 201 executes the program stored in the storing unit 208 by loading the program in a RAM (Random Access Memory) 203.

Thereby, the CPU 201 performs processing according to the above-described flowcharts or processing implemented by the composition of the above-described block diagrams. Then, the CPU 201 causes outputting from an output unit 207 or transmission from a communicating unit 209, and further recording to the storing unit 208 with respect to the results of the processing, for example, via the input/output interface 205 depending on the necessity.

Furthermore, the input unit 206 includes a keyboard, a mouse, a microphone and the like. In addition, the output unit 207 includes an LCD (Liquid Crystal Display), a speaker, and the like.

In the present specification, processing of the computer performed according to the program does not have to be performed in time series according to the order described in the flowcharts. In other words, the processing of the computer performed according to the program also includes processing executed in parallel or individually (for example, parallel processing or processing by an object).

In addition, the program may be processed by one computer (processor), or subject to distributed processing by a plurality of computers. Moreover, the program may be executed by being transferred to a remote computer.

Furthermore, in the present specification, a system refers to a whole device constituted by a plurality of devices.

The present application contains subject matter related to that disclosed in Japanese Priority Patent Application JP 2010-022372 filed in the Japan Patent Office on Feb. 3, 2010, the entire contents of which are hereby incorporated by reference.

In addition, an embodiment of the present invention is not limited to the embodiments described above, and can be modified variously in the range not departing from the gist of the present invention.

What is claimed is:

1. A recording device comprising:
image acquiring means which acquires 3D image data;
filming condition acquiring means which acquires filming condition information indicating filming conditions during filming of the 3D image data; and
recording controlling means which causes a recording medium to record the 3D image data and the filming condition information by making the data and the information correspond to each other.

2. The recording device according to claim 1, wherein the filming condition information includes:
a filming device interval which is the interval between a filming device for the left eye which films image data for the left eye out of the 3D image data and a filming device for the right eye which films image data for the right eye out of the 3D image data;
an angle of view between the filming device for the left eye and the filming device for the right eye; and
a convergence angle which is an angle formed with the optical axis of the filming device for the left eye or the filming device for the right eye and the perpendicular line to the straight line connecting the location of the filming device for the left eye and the location of the filming device for the right eye, which passes the crossing point of the optical axis of the filming device for the left eye and the optical axis of the filming device for the right eye.

3. The recording device according to claim 2, wherein the filming condition information further includes information regarding a filming distance which is a distance between a subject and the straight line connecting the location of the filming device for the left eye and the location of the filming device for the right eye.

4. The recording device according to claim 3, wherein the information regarding the filming distance is at least one of the focal length in the filming device for the left eye and the filming device for the right eye, or a zoom factor in the filming device for the left eye and the filming device for the right eye.

5. The recording device according to claim 1, wherein the filming condition information includes:
a filming device interval which is the interval between a filming device for the left eye which films image data for the left eye out of the 3D image data and a filming device for the right eye which films image data for the right eye out of the 3D image data; and
a convergence angle which is an angle formed with the optical axis of the filming device for the left eye or the filming device for the right eye and the perpendicular line to the straight line connecting the location of the filming device for the left eye and the location of the filming device for the right eye, which passes the crossing point of the optical axis of the filming device for the left eye and the optical axis of the filming device for the right eye.

6. A recording method of the recording device comprising the steps of:
acquiring 3D image data;
acquiring filming condition information indicating filming conditions during filming of the 3D image data; and
controlling a recording medium to record the 3D image data and the filming condition information by making the data and the information correspond to each other.

7. A program which causes a computer to execute processing comprising the steps of:
acquiring 3D image data;
acquiring filming condition information indicating filming conditions during filming of the 3D image data; and
controlling a recording medium to record the 3D image data and the filming condition information by making the data and the information correspond to each other.

8. An image processing device comprising:
acquiring means which acquires 3D image data and filming condition information read from a recording medium in which the 3D image data and the filming condition information indicating filming conditions during filming of the 3D image data are recorded in correspondence with each other;
parallax controlling means which corrects parallax of the 3D image data based on display condition information indicating display conditions of the 3D image data and the filming condition information; and
display controlling means which causes a display unit to display 3D images based on the 3D image data of which parallax is corrected by the parallax controlling means.

9. The image processing device according to claim 8, further comprising:
parallax detecting means which detects parallax of the 3D image data;
display distance calculating means which calculates a display distance which is the distance from a viewer to 3D images in a direction perpendicular to the display surface of the display unit during the display of the 3D images corresponding to the 3D image data acquired by the acquiring means, by using the display condition information and the parallax detected by the parallax detecting means; and
filming distance calculating means which calculates a filming distance which is the distance between a subject and the straight line connecting the location of a filming device for the left eye filming image data for the left eye out of the 3D image data and the location of a filming device for the right eye filming image data for the right eye out of the 3D image data during the filming of the 3D image data, by using the filming condition information, the display condition information, the display distance, and the parallax detected by the parallax detecting means,
wherein the filming condition information includes
a filming device interval which is the interval between the filming device for the left eye and the filming device for the right eye;
an angle of view between the filming device for the left eye and the filming device for the right eye; and
a convergence angle which is an angle formed with the optical axis of the filming device for the left eye or the filming device for the right eye and the perpendicular line to the straight line connecting the location of the filming device for the left eye and the location of the filming device for the right eye, which passes the crossing point of the optical axis of the filming device for the left eye and the optical axis of the filming device for the right eye,
wherein the display condition information includes
an inter-eye distance of the viewer;
a visual distance which is the distance from the viewer to the display surface in a direction perpendicular to the display surface; and
a screen width which is the width of the display surface in a direction of the parallax, and
wherein the parallax controlling means corrects parallax of the 3D image data so that the display distance of the 3D image data that have undergone parallax correction is equal to the filming distance.

10. The image processing device according to claim 9, wherein the parallax detecting means performs trapezoid correction for the 3D image data based on the convergence angle and the angle of view when the convergence angle is not 0, and detects the parallax of the 3D image data that have undergone the trapezoid correction.

11. The image processing device according to claim 8, further comprising:
filming distance calculating means which calculates a filming distance which is the distance between a subject and the straight line connecting the location of a filming device for the left eye filming image data for the left eye out of the 3D image data and the location of a filming device for the right eye filming image data for the right eye out of the 3D image data during the filming of the 3D image data, by using the filming condition information,
wherein the filming condition information includes
a filming device interval which is the interval between the filming device for the left eye and the filming device for the right eye;
an angle of view between the filming device for the left eye and the filming device for the right eye;
a convergence angle which is an angle formed with the optical axis of the filming device for the left eye or the filming device for the right eye and the perpendicular line to the straight line connecting the location of the filming device for the left eye and the location of the filming device for the right eye, which passes the crossing point of the optical axis of the filming device for the left eye and the optical axis of the filming device for the right eye; and
information regarding the filming distance,
wherein the display condition information includes
an inter-eye distance of the viewer;
a visual distance which is the distance from the viewer to the display surface of the display unit in a direction perpendicular to the display surface; and
a screen width which is the width of the display surface in a direction of the parallax,
wherein the filming distance calculation means calculates the filming distance based on the information regarding the filming distance, and
wherein the parallax controlling means corrects parallax of the 3D image data so that a display distance, which is the distance from a viewer to 3D images in a direction perpendicular to the display surface during the display of the 3D images corresponding to the 3D image data subjected to the parallax correction, is equal to the filming distance.

12. The image processing device according to claim 11, wherein the information regarding the filming distance is at least one of a focal length in the filming device for the left eye or the filming device for the right eye, or a zoom factor in the filming device for the left eye or the filming device for the right eye.

13. The image processing device according to claim 8,
wherein the filming condition information includes
a filming device interval which is the interval between the filming device for the left eye and the filming device for the right eye; and
a convergence angle which is an angle formed with the optical axis of the filming device for the left eye or the filming device for the right eye and the perpendicular line to the straight line connecting the location of the filming device for the left eye and the location of the filming device for the right eye, which passes the crossing point of the optical axis of the filming device for the left eye and the optical axis of the filming device for the right eye,
wherein the display condition information includes
an inter-eye distance of the viewer; and
a dot pitch of the display unit, and
wherein the parallax controlling means corrects parallax of the 3D image data according to the number of pixels obtained by dividing the dot pitch by the difference obtained by subtracting the filming device interval from the inter-eye distance when the convergence angle is 0.

14. An image processing method of an image processing device comprising the steps of:
acquiring 3D image data and filming condition information which are read from a recording medium in which the 3D image data and the filming condition information indicating filming conditions during filming of the 3D image data are recorded in correspondence with each other;
controlling parallax of the 3D image data to be corrected based on display condition information indicating display conditions of the 3D image data and the filming condition information; and
controlling a display unit to display 3D images based on the 3D image data of which parallax is corrected in the step of controlling the parallax.

15. A program which causes a computer to execute processing comprising the steps of:
acquiring 3D image data and filming condition information which are read from a recording medium in which the 3D image data and the filming condition information indicating filming conditions during filming of the 3D image data are recorded in correspondence with each other;
controlling parallax of the 3D image data to be corrected based on display condition information indicating display conditions of the 3D image data and the filming condition information; and
controlling a display unit to display 3D images based on the 3D image data of which parallax is corrected in the step of controlling the parallax.

16. A recording device comprising:
an image acquiring section which acquires 3D image data;
a filming condition acquiring section which acquires filming condition information indicating filming conditions during filming of the 3D image data; and
a recording controlling section which causes a recording medium to record the 3D image data and the filming condition information by making the data and the information correspond to each other.

17. An image processing device comprising:
an acquiring section which acquires 3D image data and filming condition information read from a recording medium in which the 3D image data and the filming condition information indicating filming conditions during filming of the 3D image data are recorded in correspondence with each other;
a parallax controlling section which corrects parallax of the 3D image data based on display condition information indicating display conditions of the 3D image data and the filming condition information; and
a display controlling section which causes a display unit to display 3D images based on the 3D image data of which parallax is corrected by the parallax controlling section.
